(19) United States
(12) Patent Application Publication
(10) Pub. No.: US 2021/0295788 A1
(43) Pub. Date: Sep. 23, 2021

(54) Display Panel Driving Method and Display Panel Driving Circuit Thereof

(71) Applicant: NOVATEK Microelectronics Corp., Hsin-Chu (TW)

(72) Inventor: Te-Hsien Kuo, Keelung City (TW)

(21) Appl. No.: 16/821,969

(22) Filed: Mar. 17, 2020

(51) Int. Cl. G09G 3/36; G09G 3/34

(52) U.S. Cl. CPC G09G 3/3607; G09G 2320/0257; G09G 2320/0247; G09G 3/3413

(57) ABSTRACT

A display panel driving circuit for driving a plurality of subpixels of a display panel includes a compensation circuit. The compensation circuit is configured to convert a first input gray level data into a first output gray level data corresponding to a first data signal for a first subpixel of the plurality of subpixels. The first subpixel is located in a first zone of a plurality of zones of the display panel. A first difference between the first input gray level data and the first output gray level data is associated with a first voltage polarity of the first data signal or the first zone.

### BACKGROUND OF THE INVENTION

### 1. Field of the Invention

The present invention relates to a display panel driving method and a display panel driving circuit, and more particularly, to a display panel driving method and a display panel driving circuit so as to eliminate flicker or line afterimage and ensure high display quality.

### 2. Description of the Prior Art

Different alignments of liquid crystals result in different polarization and refraction effects on light passing through the liquid crystals. Thus, light transmission ratios may be controlled in a liquid crystal display device by adjusting the alignments of the liquid crystals. On the other hand, each liquid crystal must be driven by a subpixel voltage of a periodically alternating voltage polarity, which is the so-called voltage polarity inversion driving, so as to avoid permanently damages on the liquid crystals due to deformation and effects of ion trapping and direct current residue.

In a liquid crystal display device, although a common voltage is in the middle of a voltage range between a data signal with negative voltage polarity and a data signal with positive voltage polarity, the difference between a subpixel voltage with negative voltage polarity for a subpixel and the common voltage differs from the difference between a subpixel voltage with positive voltage polarity for the subpixel and the common voltage due to the occurrence of feed through phenomenon. The subpixel voltage of the subpixel may shift from the data signal by a feed through voltage. Flickering occurs and causes deterioration in display quality when the subpixel is subject to the subpixel voltage periodically alternating between positive voltage polarity and negative voltage polarity but the common voltage is not equal to the average of the subpixel voltage with positive voltage polarity and subpixel voltage with negative voltage polarity.

Manufacture processes may cause different feed through voltages of the subpixels at different positions. As the feed through voltages vary from one subpixel to another, it may be difficult to eliminate flicker. Even if the common voltage for all the subpixels equals the average of the subpixel voltage with positive voltage polarity and the subpixel voltage with negative voltage polarity of the subpixel at the center of the liquid crystal display device, the feed through phenomenon cannot be cancelled out uniformly within the liquid crystal display device. The display quality in other areas may be worse than that in the middle area, leading to unevenness in display quality.

Besides, Please refer to FIG. 1, which is a schematic diagram illustrating a current-voltage characteristic curve of a thin-film transistor in the prior art. The current-voltage characteristic curve shows a relationship between a drain-to-source current Ids flowing through the thin-film transistor and a gate-to-source voltage Vgs across its terminals. As shown in FIG. 1, the gate-to-source voltage Vgs has an impact on conductivity of the thin-film transistor. In such a situation, the difference between the subpixel voltage with negative voltage polarity for the subpixel and the common voltage differs from the difference between the subpixel voltage with positive voltage polarity for the subpixel and the common voltage due to the conductivity of the thin-film transistor. Line afterimage may appear in the liquid crystal display device as a result of the imbalance of the subpixel voltage with respect to the common voltage. Thus, there is a need to improve the prior art.

### SUMMARY OF THE INVENTION

In order to solve aforementioned problem(s), the present invention provides a display panel driving method and a display panel driving circuit of high display quality so as to eliminate flicker or line afterimage and ensure high display quality.

The present invention discloses a display panel driving circuit for driving a plurality of subpixels of a display panel. The display panel driving circuit includes a compensation circuit. The compensation circuit is configured to convert a first input gray level data into a first output gray level data corresponding to a first data signal for a first subpixel of the plurality of subpixels. The first subpixel is located in a first zone of a plurality of zones of the display panel. A first difference between the first input gray level data and the first output gray level data is associated with a first voltage polarity of the first data signal or the first zone.

The present invention discloses a display panel driving method for driving a plurality of subpixels of a display panel. The display panel driving method includes converting a first input gray level data into a first output gray level data corresponding to a first data signal for a first subpixel of the plurality of subpixels. The first subpixel is located in a first zone of a plurality of zones of the display panel. A first difference between the first input gray level data and the first output gray level data is associated with a first voltage polarity of the first data signal or the first zone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating current-voltage characteristic curve of a thin-film transistor.

FIG. 2 is a schematic diagram of a display module according to an embodiment of the present invention.

FIG. 3 is a flowchart of a driving method according to an embodiment of the present invention.

FIG. 4 is a timing diagram of a polarity signal, agate driving signal, a data signal, and a subpixel voltage based on the driving method shown in FIG. 3.

FIG. 5 is a schematic diagram illustrating a relation between gray levels and gray-level voltages of data signals after compensation according to an embodiment of the present invention.

FIG. 6 is a schematic diagram of a timing controller according to an embodiment of the present invention.

FIG. 7, FIG. 9 and FIG. 11 are schematic diagrams illustrating subpixel voltages of subpixels during different time intervals respectively according to an embodiment of the present invention.

FIG. 8 is a timing diagram of the polarity signal, the gate driving signal, data signals, and subpixel voltages corresponding to FIG. 7.

FIG. 10 is a timing diagram of the polarity signal, the gate driving signal, data signals, and subpixel voltages corresponding to FIG. 9.

FIG. 12 is a timing diagram of the polarity signal, the gate driving signal, data signals, and subpixel voltages corresponding to FIG. 11.

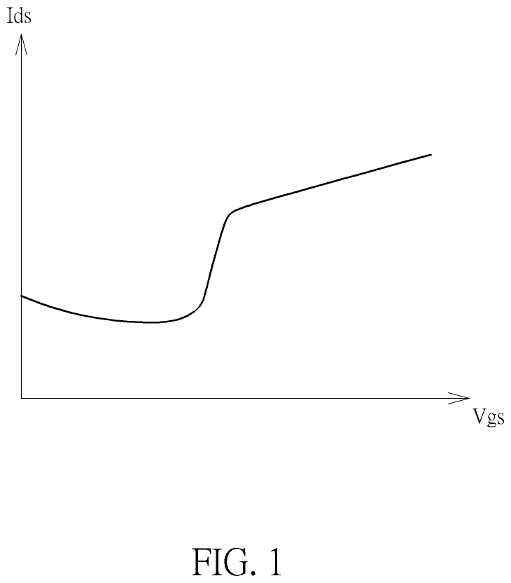

### DETAILED DESCRIPTION

Certain terms are used throughout the following description and claims to refer to particular components. Manufacturers may refer to a component by different names as one skilled in the art may appreciate. Therefore, components shall be distinguished according to function instead of name. In the following description and claims, the terms “include” and “comprise” are used in an open-ended fashion, and thus should be interpreted to mean “include, but not limited to”. Also, the term “couple” is intended to mean either an indirect or direct electrical connection. Accordingly, if one device is coupled to another device, the connection may belong to a direct electrical connection or an indirect electrical connection via other devices and connections.

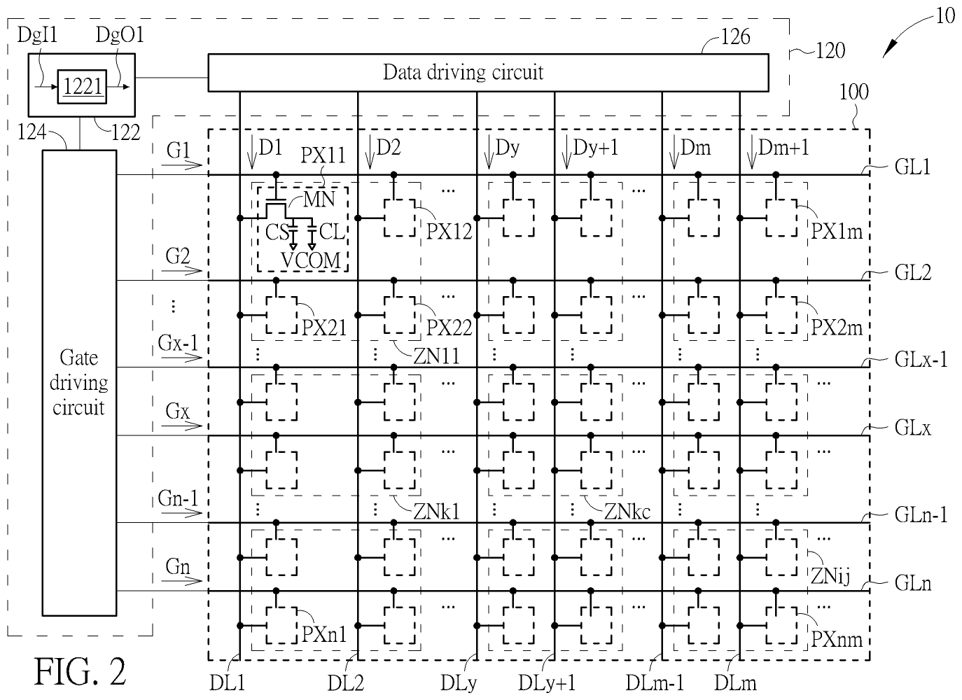

Please refer to FIG. 2. FIG. 2 is a schematic diagram of a display module 10 according to an embodiment of the present invention. The display module 10 may be a thin film transistor (TFT) liquid crystal display (LCD) device, and may be adopted in electronic products capable of rendering images—for example, a laptop and a smart phone. The display module 10 includes a display panel 100 and a (display panel) driving circuit 120. The display panel 100 includes a plurality of gate lines GL1-GLn, a plurality of data lines DL1-DLm and a plurality of subpixels PX11-PXnm arranged in an array, where m, n are positive integers. Each of the subpixels PX11-PXnm includes capacitors CS, CL, and a transistor TRS coupled between one of the gate lines GL1-GLn and one of the data lines DL1-DLm. Each capacitor CL represents an equivalent capacitor of one of the subpixels PX11-PXnm of the display panel 100. Each capacitor CS is a storage capacitor.

The driving circuit 120 for driving the subpixels PX11-PXnm may include a timing controller 122, a gate driving circuit 124 and a data driving circuit 126. The timing controller 122 is coupled to the gate driving circuit 124 and the data driving circuit 126. The timing controller 122 is configured to provide operation signals (such as a polarity signal and timing signals) to the gate driving circuit 124 and the data driving circuit 126 so as to control operations of the gate driving circuit 124 and the data driving circuit 126. The gate driving circuit 124 is configured to generate a plurality of gate driving signals G1-Gn according to part of the operation signals and transmit the gate driving signals G1-Gn to the gate lines GL1-GLn so as to enable the transistors TRS of the subpixels PX11-PXnm row by row. The data driving circuit 126 is configured to send data signals D1-Dm to the data lines DL1-DLm according to part of the operation signals so as to transmit the data signals D1-Dm to the corresponding subpixels PX11-PXnm.

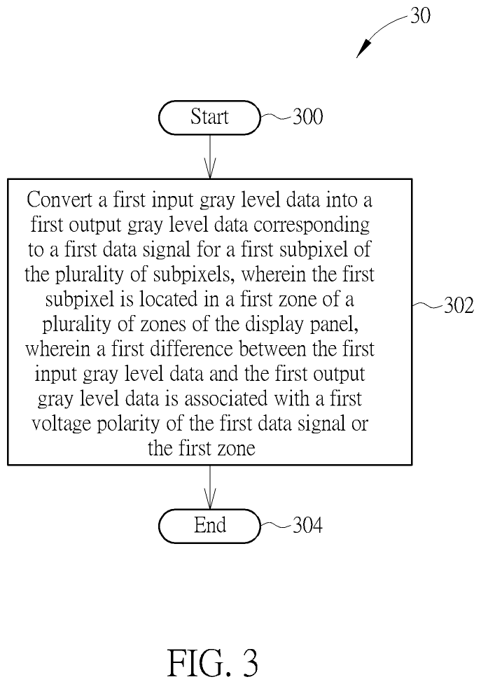

Please refer to FIG. 3, which is a flowchart of a (display panel) driving method 30 according to an embodiment of the present invention. Specifically, operations of the driving circuit 120 to update subpixel voltages of the subpixels PX11-PXnm may be summarized as the driving method 30. The driving method 30 includes following steps:

Step 300: Start.

Step 302: Convert a first input gray level data into a first output gray level data corresponding to a first data signal for a first subpixel of the plurality of subpixels, wherein the first subpixel is located in a first zone of a plurality of zones of the display panel, wherein a first difference between the first input gray level data and the first output gray level data is associated with a first voltage polarity of the first data signal or the first zone.

Step 304: End.

Briefly, the timing controller 122 may include a compensation circuit 1221, which is configured to convert an input gray level data DgI1 into an output gray level data DgO1, which corresponds to a data signal (for example, the data signal D1) for a subpixel (for example, the subpixels PX21) located in a zone (for example, the zone ZN11) of the display panel 100. A difference (also referred to as a compensation difference) between the input gray level data DgI1 and the output gray level data DgO1 is associated with a voltage polarity of the data signal (namely, the data signal D1 with negative or positive voltage polarity) or the zone (namely, the zone ZN11). In other words, compensation differences for the subpixels PX11-PXnm are functions of the locations of the subpixels PX11-PXnm respectively. The compensation differences for a subpixel (for example, the subpixels PX21) vary according to whether the data signal (for example, the data signal D1) for the subpixel (for example, the subpixels PX21) has negative or positive voltage polarity.

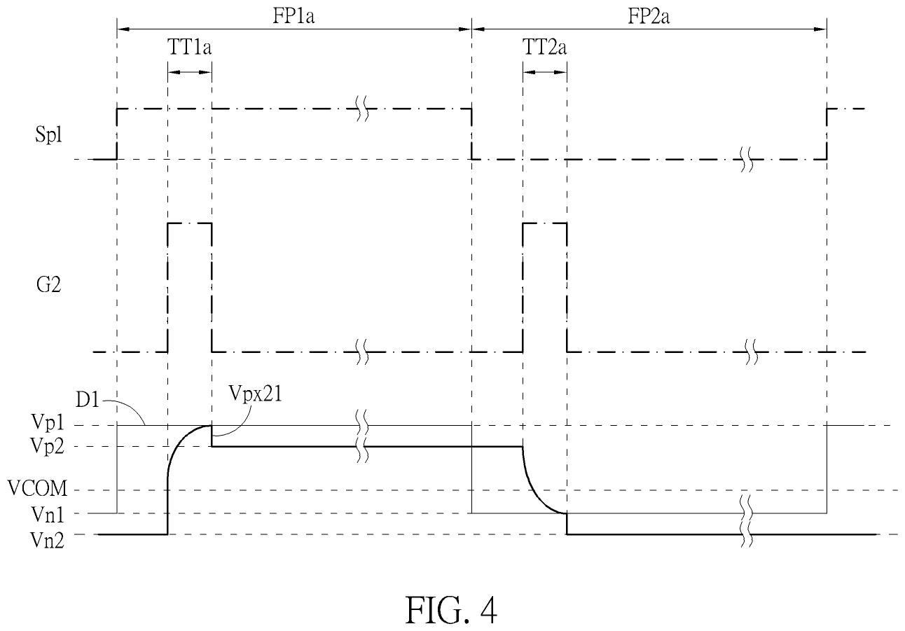

Please refer to FIG. 4 for specific operations of the driving method 30 shown in FIG. 3. FIG. 4 is a timing diagram of a polarity signal Sp1, the gate driving signal G2, the data signal D1, and a subpixel voltage Vpx21 based on the display panel driving method 30 according to an embodiment of the present invention. In FIG. 4, a thick solid curve represents the subpixel voltage Vpx21, which corresponds to charges accumulated in the subpixel PX21, and a thin solid curve represents the data signal D1. In FIG. 4, the display module 10 shown in FIG. 2 is driven by means of frame inversion method for illustrative purposes, but is not limited thereto. The frame inversion method means that the voltage polarities of the data signals D1-Dm with respect to the common voltage VCOM (referred to as the voltage polarities of the data signals D1-Dm hereinafter) are inverted by every frame according to the polarity signal Sp1. Consequently, the data signals D1-Dm have the same voltage polarity (for example, positive voltage polarity) in one frame (for example, during a frame period FP1a), while the data signals D1-Dm has the opposite voltage polarity (for example, negative voltage polarity) in the next frame (for example, during a frame period FP2a).

Take the subpixel PX21 as an example. The data line DL1 transmits the data signal D1 of a gray-level voltage Vp1 from the data driving circuit 126 to the subpixels PX11-PXn1 during the frame period FP1a. The gray-level voltage Vp1 is higher than the common voltage VCOM so that the voltage polarity of the data signal D1 is positive. The subpixels PX21-PX2m connected to the gate lines GL2 are simultaneously turned on when the gate line GL2 is selected with the gate driving signal G2 during a time interval TT1a. A subpixel voltage Vpx21 of the subpixel PX21 reaches the gray-level voltage Vp1 during the time interval TT1a, but drops to a gray-level voltage Vp2 after the time interval TT1a due to the feed through phenomenon. Similarly, the data line DL1 transmits the data signal D1 of a gray-level voltage Vn1 from the data driving circuit 126 to the subpixels PX11-PXn1 during the frame period FP2a. The gray-level voltage Vn1 is lower than the common voltage VCOM so that the voltage polarity of the data signal D1 is negative. The subpixels PX21-PX2m connected to the gate lines GL2 are simultaneously turned on when the gate line GL2 is selected with the gate driving signal G2 during a time interval TT2a. The subpixel voltage Vpx21 of the subpixel PX21 reaches the gray-level voltage Vn1 during the time interval TT2a, but drops to a gray-level voltage Vn2 after the time interval TT2a due to the feed through phenomenon.

In terms of the subpixel voltage Vpx21 shown in FIG. 3, the difference between the gray-level voltage Vn2 with negative voltage polarity for the subpixel PX21 and the common voltage VCOM equals or at least approximates to the difference between the gray-level voltage Vp2 with positive voltage polarity for the subpixel PX21 and the common voltage VCOM. The subpixel voltage Vpx21 is averaged to a voltage level near the common voltage VCOM, when the voltage polarities of the subpixel voltage Vpx21 are switched in response to the polarity signal Sp1. In other words, the waveform of the subpixel voltage Vpx21 of the subpixel PX21 is symmetric or balanced with respect to the common voltage VCOM, thereby eliminating flicker. To balance the waveform of the subpixel voltage Vpx21, the difference between the gray-level voltage Vn1 for the data signal D1 and the common voltage VCOM differs from the difference between the gray-level voltage Vp1 for the data signal D1 and the common voltage VCOM. Correspondingly, the compensation circuit 1221 may convert a (first) input gray level data (for example, the input gray level data DgI1), which may correspond to the gray-level voltage Vp2, into a (first) output gray level data (for example, the output gray level data DgO1), which corresponds to the data signal D1 of the gray-level voltage Vp1. Besides, the compensation circuit 1221 may convert a (second) input gray level data, which may correspond to the gray-level voltage Vn2, into a (second) output gray level data, which corresponds to the data signal D1 of the gray-level voltage Vn1. In other words, the subpixel voltage Vpx21 (for example, the gray-level voltage Vp2 or Vn2) of the subpixel PX21 deviates from the data signal D1 (for example, the gray-level voltage Vp1 or Vn1) by a voltage associated with the (first) compensation difference corresponding to positive voltage polarity and/or the (second) compensation difference corresponding to negative voltage polarity.

The (first) input gray level data involves a gray level corresponds to a data signal to be adjusted (for example, the data signal D1 without compensation) or a subpixel voltage after adjustments (for example, the subpixel voltage Vpx21) by the compensation circuit 1221. The (first) output gray level data involves a gray level corresponds to a data signal after adjustments (namely, the current gray-level voltage of the data signal D1) by the compensation circuit 1221. When the data signal D1 with positive voltage polarity is changed from the gray-level voltage Vp2 to the gray-level voltage Vp1, the gray level rises. Correspondingly, the (first) input gray level data is increased to the (first) output gray level data. Likewise, the (second) input gray level data involves a gray level corresponds to a data signal to be adjusted (for example, the data signal D1) or a subpixel voltage after compensation (for example, the subpixel voltage Vpx21) by the compensation circuit 1221. The (second) output gray level data involves a gray level corresponds to a data signal after compensation (namely, the current gray-level voltage of the data signal D1) by the compensation circuit 1221. Nevertheless, when the data signal D1 with negative voltage polarity rises from the gray-level voltage Vn2 to the gray-level voltage Vn1, the gray level drops. Correspondingly, the (second) input gray level data is decreased to the (second) output gray level data. The first input gray level data may equal the second input gray level data; however, the first output gray level data and the second output gray level data are compensated individually.

That is to say, as the voltage polarity of the data signal D1 of the gray-level voltage Vp1 (regarded as a first data signal), which corresponds to the (first) output gray level data, is opposite to the voltage polarity of the data signal D1 of the gray-level voltage Vn1 (regarded as a second data signal), which corresponds to the (second) output gray level data, the (first) compensation difference between the (first) input gray level data and the (first) output gray level data corresponding to positive voltage polarity is different from the (second) compensation difference between the (second) input gray level data and the (second) output gray level data corresponding to negative voltage polarity. Accordingly, the (first) compensation difference or/and the (second) compensation difference is/are associated with the voltage polarity of the data signal D1, thereby improving display quality.

It should be noted that the driving method 30 is an exemplary embodiment of the present invention, and those skilled in the art may readily make different alternations and modifications. For instance, the (first) compensation difference corresponding to positive voltage polarity or/and the (second) compensation difference corresponding to negative voltage polarity may be associated with the current (gray-level) voltage (namely, the gray-level voltage Vp1 or Vn1) of the data signal (namely, the data signal D1). It is because current gray level has an influence on the feed through voltage. Therefore, a data signal (for example, the data signal D1) may be modified according to its current (gray-level) voltage, such that the average of the subpixel voltage (for example, the gray-level voltage Vp2) of a subpixel (for example, the subpixel PX21) with positive voltage polarity and the subpixel voltage (for example, the gray-level voltage Vn2) of the subpixel (namely, the subpixel PX21) with negative voltage polarity for each gray level is equal to that for another gray level (namely, the average of the subpixel voltage of the subpixel with positive voltage polarity and the subpixel voltage of the subpixel with negative voltage polarity for another gray level) after the compensation of the compensation circuit 1221. No matter which gray level a subpixel (for example, the subpixel PX21) is at, the (first) output gray level data or the (second) output gray level data, which is/are associated with a current (gray-level) voltage (for example, the gray-level voltage Vp1 or Vn1) of a data signal (for example, the data signal D1), is converted from the (first) input gray level data or the (second) input gray level data according to the current (gray-level) voltage (namely, the gray-level voltage Vp1 or Vn1) of the data signal (namely, the data signal D1), thereby improving display quality.

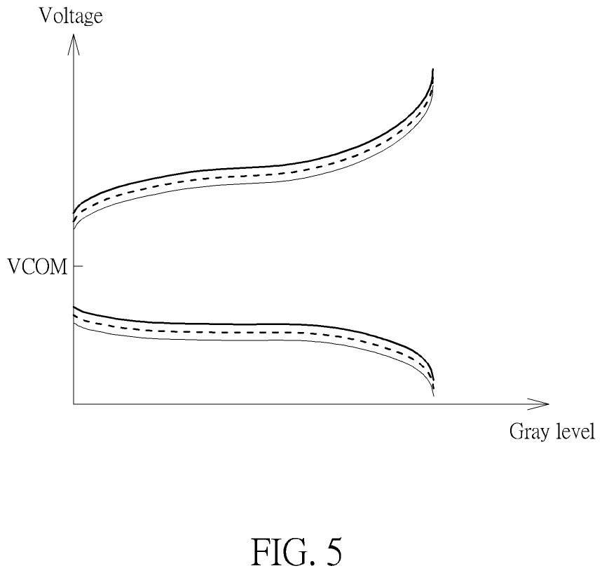

In some embodiments, the (first) compensation difference(s) corresponding to positive voltage polarity or/and the (second) compensation difference(s) corresponding to negative voltage polarity may be associated with a zone (for example, the zone ZN11) in which a subpixel (for example, the subpixel PX21) is located. Please refer to FIG. 2 along with FIG. 5, which is a schematic diagram illustrating a relation between gray levels and gray-level voltages of data signals after compensation according to an embodiment of the present invention. As shown in FIG. 2, the display panel 100 is divided into a plurality of zones ZN11-ZNij, where i and j are positive integers. Each of the zones ZN11-ZNij has at least one of the subpixels PX11-PXnm disposed in. For instance, there are four subpixels PX11-PX22 in the zone ZN11. The size of one zone (for example, the zone ZN11) may be identical to or different from that of another (for example, the zone ZNij). For instance, in some embodiments, there may be merely one subpixel PXnm in the zone ZNij.

In FIG. 2, the capacitors CS and CL of one of the subpixels PX11-PXnm may be coupled between its subpixel voltage and a common voltage VCOM of the display module 10. As shown in FIG. 5, there may be only one kind of common voltage, and all the subpixels PX11-PXnm are subjected to the same one common voltage VCOM. In some embodiments, the common voltage VCOM for all the subpixels equals the average of the subpixel voltage with positive voltage polarity and the subpixel voltage with negative voltage polarity of the subpixel at the center of all the subpixels PX11-PXnm in the display panel 100. In some embodiments, the common voltage VCOM for all the subpixels equals the average of the subpixel voltage with positive voltage polarity and the subpixel voltage with negative voltage polarity of the subpixel in a zone (for example, the zone ZN11) is located near a center of the display panel 100. Without setting different common voltages for different the subpixels PX11-PXnm in different regions ZN11-ZNij of the display panel 100, there is no need to dispose extra common voltage components. Besides, circuitry or wiring may be simplified and its area may be minimized.

If waveforms of the subpixel voltages of all the subpixels PX11-PXnm are to be symmetric or balanced with respect to the common voltage VCOM, the compensation circuit 1221 must convert input gray level data (for example, the input gray level data DgI1), which may correspond to the subpixel voltages of the subpixels PX11-PXnm, into output gray level data (for example, the output gray level data DgO1), which corresponds to the data signals for all the subpixels PX11-PXnm. Since manufacturing process may cause feed through voltages of the subpixels PX11-PXnm vary from one to another, the (first) compensation difference(s) corresponding to positive voltage polarity or/and the (second) compensation difference(s) corresponding to negative voltage polarity may be associated with the zones ZN11-ZNij in which the subpixels PX11-PXnm are located.

For instance, if a zone ZNkc is located in (or near) a center of the display panel 100, the (first) compensation difference(s) corresponding to positive voltage polarity or/and the (second) compensation difference(s) corresponding to negative voltage polarity for the zone ZNkc may be equal or close to zero. It is because the common voltage VCOM for all the subpixels PX11-PXnm is moved to the middle of the subpixel voltage with positive voltage polarity and subpixel voltage with negative voltage polarity of the subpixel (s) in the zone ZNkc. In FIG. 5, a dashed curve represents a gamma curve between gray levels and gray-level voltages in the zone ZNkc after compensation. According to FIG. 5, the gamma curve for the zone ZNkc, located near the center of the display panel 100, is symmetric or balanced with respect to a virtual straight line of the common voltage VCOM, which is parallel to the x-axis at a distance (namely, the common voltage VCOM) from the x-axis. It is unnecessary to adjust the gray-level voltages of the data lines near the center of the display panel 100. Therefore, the compensation circuit 1221 may not convert the (first) input gray level data into the (first) output gray level data.

On the other hand, if a zone (for example, the zone ZN11 or ZNij) is located near four outermost sides of the display panel 100, the (first) compensation difference(s) corresponding to positive voltage polarity or/and the (second) compensation difference(s) corresponding to negative voltage polarity may be nonzero. In FIG. 5, a thick solid curve and a thin solid curve respectively represent gamma curves between gray levels and gray-level voltages in the zones ZN11 and ZNij after compensation. According to FIG. 5, the gamma curves for the zones ZN11 and ZNij, located near the outermost sides of the display panel 100, is asymmetric with respect to the virtual straight line of the common voltage VCOM. It is necessary to adjust the gray-level voltages of the data lines away from the center of the display panel 100. Moreover, the gray level corresponding to positive voltage polarity for the zone ZN11 is higher than the gray level corresponding to positive voltage polarity for the zone ZNij, while the gray level corresponding to negative voltage polarity for the zone ZN11 is lower than the gray level corresponding to negative voltage polarity for the zone ZNij. Accordingly, the (first) compensation difference(s) corresponding to positive voltage polarity or/and the (second) compensation difference(s) corresponding to negative voltage polarity may be associated with a zone in which a subpixel is located, thereby improving display quality. The (first) compensation difference(s) corresponding to positive voltage polarity are set in a way separately and differently from the (second) compensation difference(s) corresponding to negative voltage polarity.

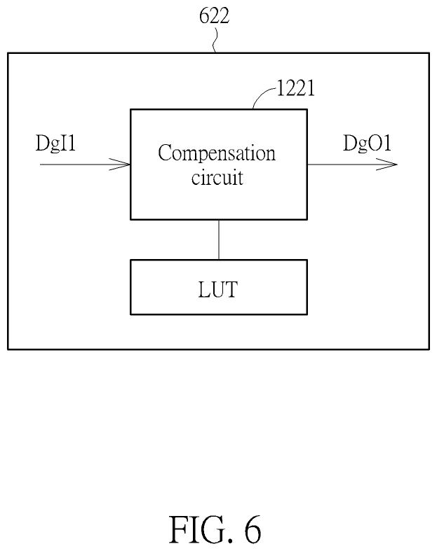

In some embodiments, the timing controller 122 is modified for the compensation of the compensation circuit 1221. Please refer to FIG. 6, Table 1 and Table 2. FIG. 6 is a schematic diagram of a timing controller 622 according to an embodiment of the present invention. Table 1 and Table 2 list possible elements of a look-up table LUT respectively. The timing controller 622 shown in FIG. 6 is similar to the timing controller 122 shown in FIG. 2. Therefore, the same numerals and notations denote the same components in the following description, and the similar parts are not detailed redundantly. Distinct from the timing controller 122, the timing controller 622 further includes the look-up table LUT, which stores data associated with the compensation from the (first) input gray level data or the (second) input gray level data to the (first) output gray level data or the (second) output gray level data. The data may be stored in digital form (or in analog form). In some embodiments, the timing controller 622 may include a storage circuit such as a read only memory (ROM) to store the look-up table LUT.

TABLE 1

| | input gray level data | | | | |
|---|---|---|---|---|---|
| | 0 | 1 | . . . | 254 | 255 |
| compensation | CDF (0) | CDF (1) | . . . | CDF (254) | CDF (255) |
| difference | | | | | |

TABLE 2

| | input gray level data | | | | |
|---|---|---|---|---|---|
| | 0-31 | 32-63 | . . . | 192-223 | 224-255 |
| compensation | CDR (0) | CDR (32) | . . . | CDR (192) | CDR (224) |
| difference | | | | | |

In some embodiments, the look-up table LUT may store a (first) compensation difference of a data signal (for example, the data signal D1) with positive voltage polarity and a (second) compensation difference of the data signal (namely, the data signal D1) with negative voltage polarity. Correspondingly, exact values of compensation differences CDF(0)-CDF(255) listed in Table 1 and exact values of compensation differences CDR(0)-CDR(224) listed in Table 2 may be determined according to voltage polarity. In some embodiments, the look-up table LUT may store (first) compensation differences of the data signal (namely, the data signal D1) with positive voltage polarity but different gray levels, and store (second) compensation differences of the data signal (namely, the data signal D1) with negative voltage polarity but different gray levels. Correspondingly, the exact values of the compensation differences CDF(0)-CDF(255) listed in the second row of Table 1 may be determined according to input gray level data listed in the first row of Table 1. The gray levels may be 256 gradations for display module 10 to render images, but is not limited thereto. In some embodiments, the look-up table LUT may store (first) compensation differences of the data signal (namely, the data signal D1) with positive voltage polarity but different gray level ranges such as 0-31, 32-63, . . . , 224-255, and store (second) compensation differences of the data signal (namely, the data signal D1) with negative voltage polarity but different gray level ranges such as 0-31, 32-63, . . . , 224-255. Correspondingly, the exact values of the compensation differences CDR(0)-CDR(224) listed in the second row of Table 2 may be determined according to gray level ranges of the input gray level data listed in the first row of Table 2.

In some embodiments, the look-up table LUT may store the (first) compensation differences and the (second) compensation differences for all the zones ZN11-ZNij. Correspondingly, the exact values of the compensation differences CDF(0)-CDF(255) listed in Table 1 and the exact values of the compensation differences CDR(0)-CDR(224) listed in Table 2 may be determined according to a zone (for example, the zone ZN11) in which a subpixel (for example, the subpixel PX21) is located. In some embodiments, the timing controller 122 is able to recognize which zone each of the subpixels PX11-PXnm is located in and which voltage polarity each of the subpixels PX11-PXnm corresponds to according to the operation signals (such as the polarity signal Sp1 and the timing signals). In some embodiments, the (first) input gray level data is converted into the (first) output gray level data according to one of positive compensation lookup tables of the look-up table LUT for positive voltage polarity. The (second) input gray level data is converted into the (second) output gray level data according to one of negative compensation lookup tables of the look-up table LUT for negative voltage polarity. One of the negative compensation lookup tables and one of the positive compensation lookup tables are associated with one of the zones ZN11-ZNij.

As the (first) input gray level data or the (second) input gray level data is converted to the (first) output gray level data or the (second) output gray level data according to the look-up table LUT, flicker disappears.

To eliminate line afterimage, in some embodiments, the look-up table LUT may store the (first) compensation differences and the (second) compensation differences corresponding to a previous input gray level data. In other words, the (first) compensation difference (s) corresponding to positive voltage polarity or/and the (second) compensation difference(s) corresponding to negative voltage polarity may be associated with a previous (gray-level) voltage of the data signal (for example, the data signal D1). Please refer to Table 3 and Table 4. Table 3 and Table 4 list possible elements of a look-up table LUT respectively. Exact values of compensation differences CDF(0,0)-CDF(255,255) listed in Table 3 may be determined according to the next input gray level data listed in the topmost row of Table 3 and the previous input gray level data listed in the leftmost column of Table 3. Exact values of compensation differences CDR(0,0)-CDR(224,224) listed in Table 4 may be determined according to gray level ranges of the next input gray level data listed in the topmost row of Table 4 and gray level ranges of the previous input gray level data listed in the leftmost column of Table 4. As set forth above, the exact values of the compensation differences CDF(0,0)-CDF (255, 255) listed in Table 3 and the exact values of the compensation differences CDR (0, 0)-CDR (224, 224) listed in Table 2 may be determined according to voltage polarity.

TABLE 3

| | | next input gray level data | | | | |
|---|---|---|---|---|---|---|
| | | 0 | 1 | . . . | 254 | 255 |
| previous | 0 | CDF (0, 0) | CDF (0, 1) | . . . | CDF (0, 254) | CDF (0, 255) |
| input gray | 1 | CDF (1, 0) | CDF (1, 1) | . . . | CDF (1, 254) | CDF (1, 255) |
| level data | . . . | . . . | . . . | . . . | . . . | . . . |
| | 254 | CDF (254, 0) | CDF (254, 1) | . . . | CDF (254, 254) | CDF (254, 255) |
| | 255 | CDF (255, 0) | CDF (255, 1) | . . . | CDF (255, 254) | CDF (255, 255) |

TABLE 4

| | | next input gray level data | | | | |
|---|---|---|---|---|---|---|
| | | 0-31 | 32-63 | . . . | 192-223 | 224-255 |
| previous | 0-31 | CDR (0, 0) | CDR (0, 32) | . . . | CDR (0, 192) | CDR (0, 224) |
| input gray | 32-63 | CDR (32, 0) | CDR (32, 32) | . . . | CDR (32, 192) | CDR (32, 224) |
| level data | . . . | . . . | . . . | . . . | . . . | . . . |
| | 192-223 | CDR (192, 0) | CDR (192, 32) | . . . | CDR (192, 192) | CDR (192, 224) |
| | 224-255 | CDR (224, 0) | CDR (224, 32) | . . . | CDR (224, 192) | CDR (224, 224) |

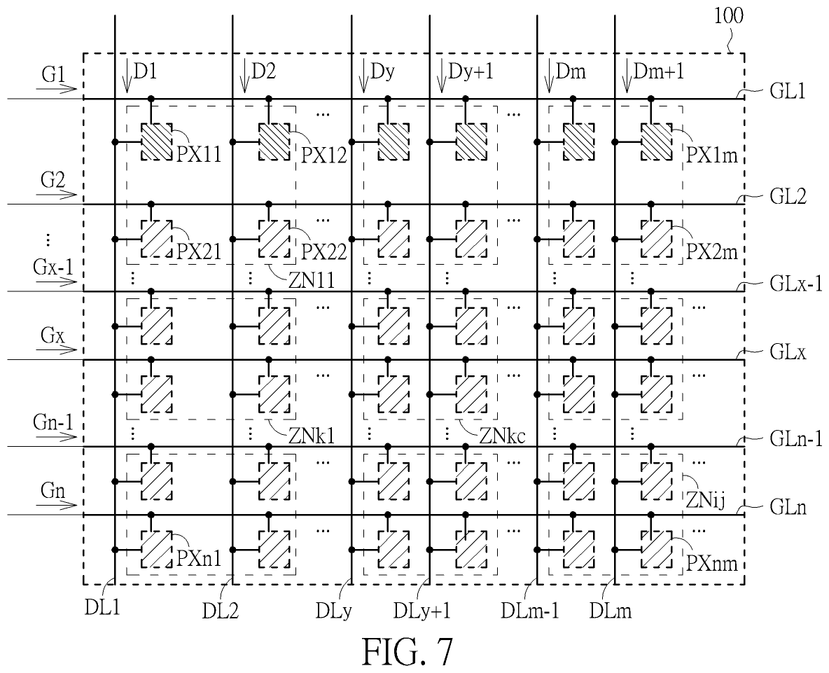

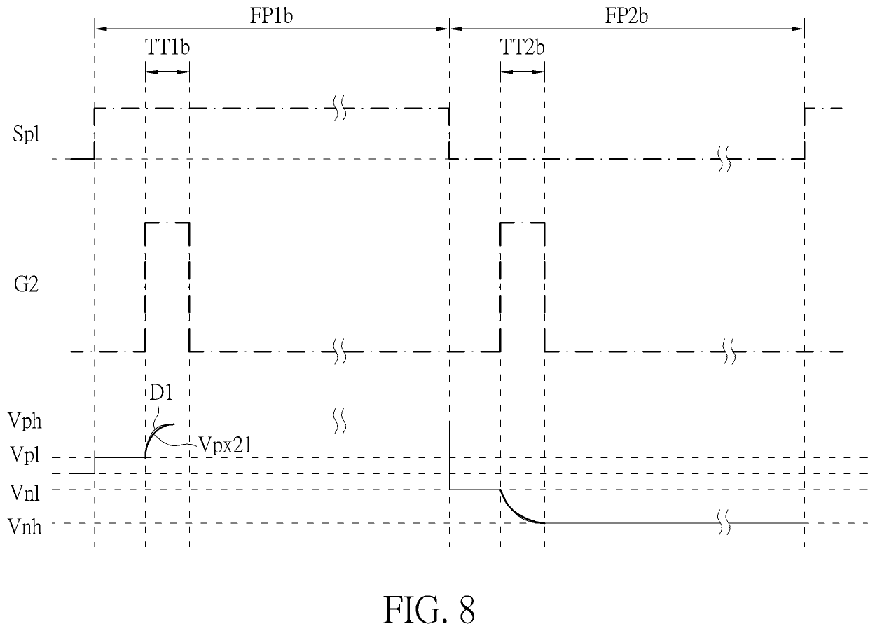

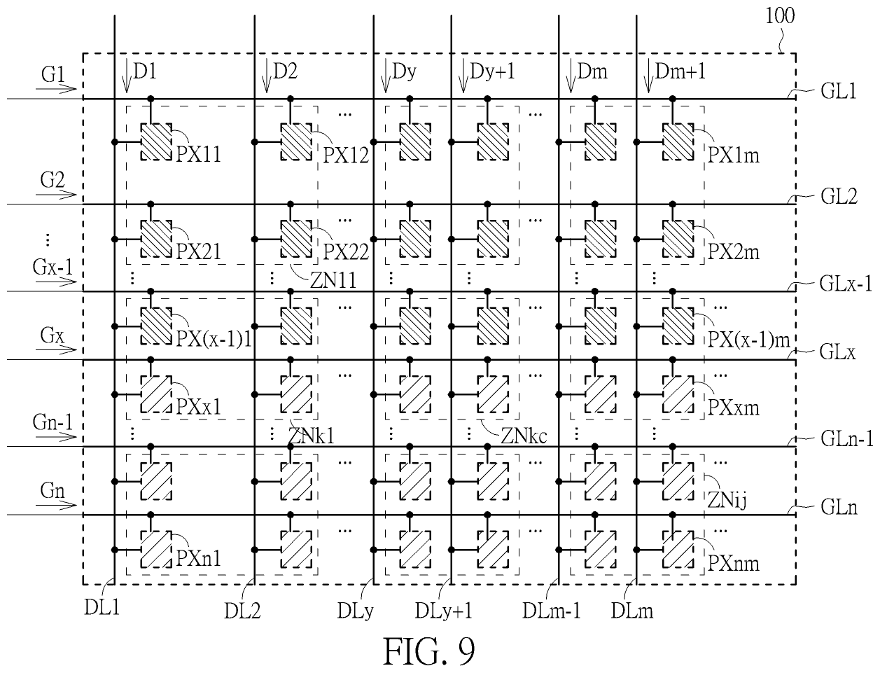

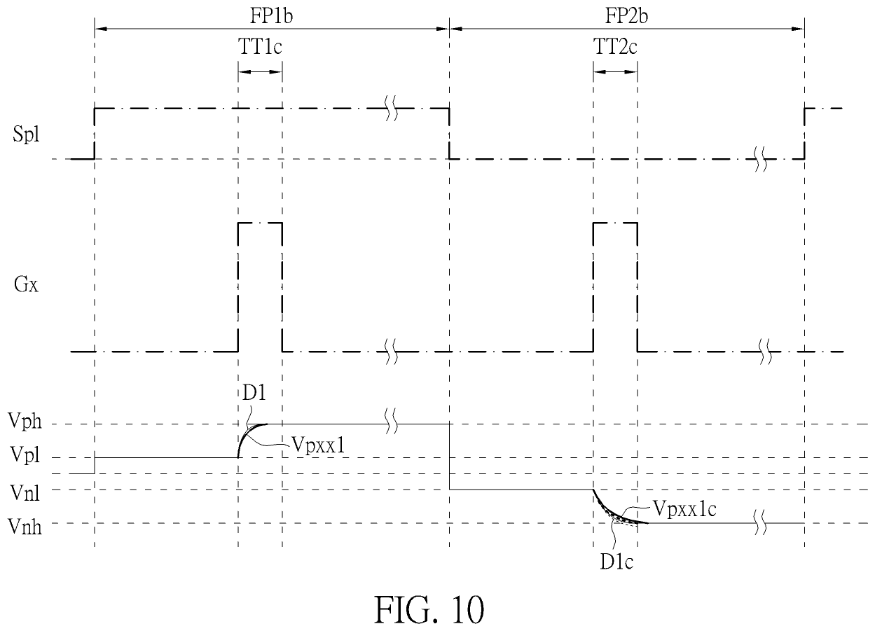

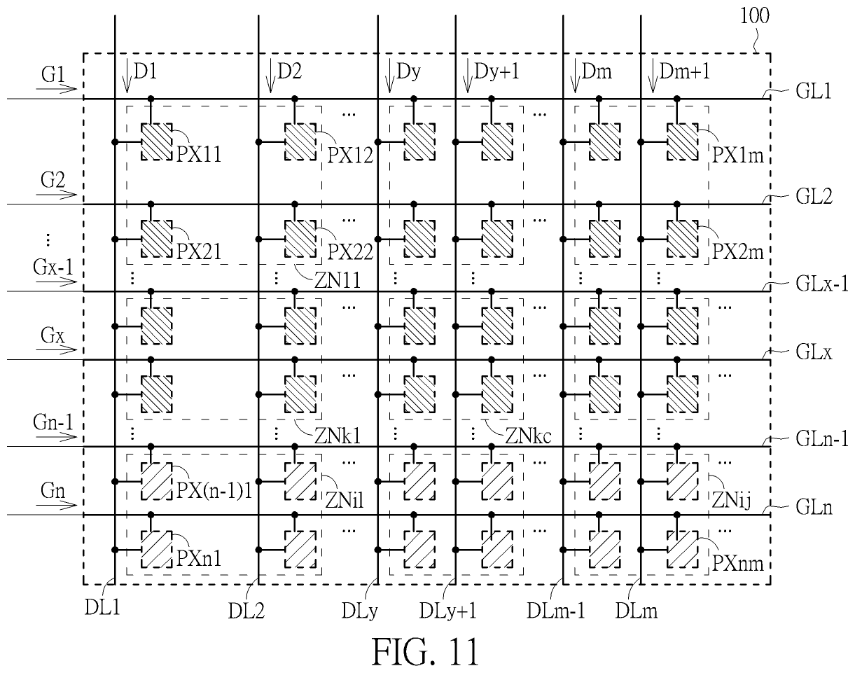

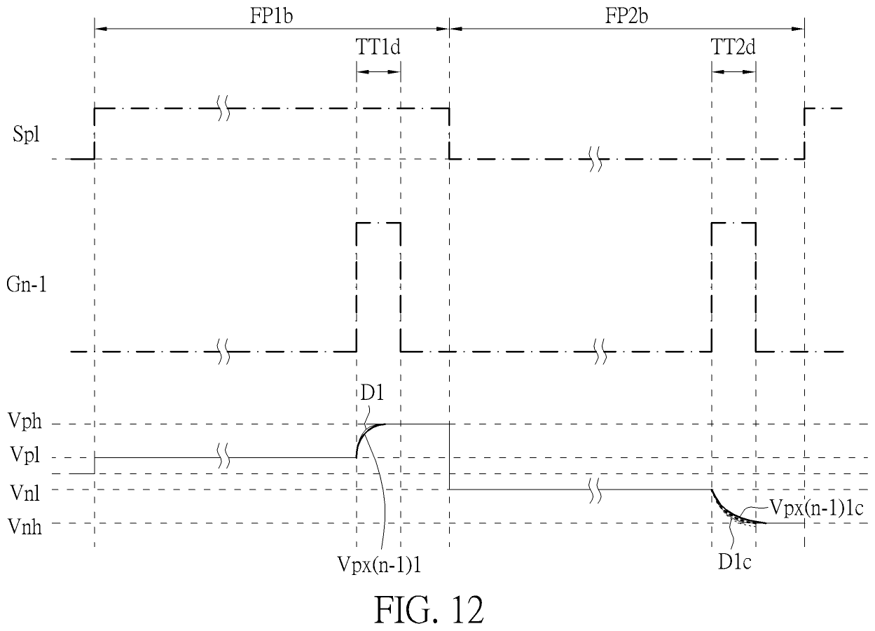

In addition, the exact values of the compensation differences CDF(0,0)-CDF(255,255) listed in Table 3 and the exact values of the compensation differences CDR(0,0)-CDR(224,224) listed in Table 4 may be determined according to a zone (for example, the zone ZN11) in which a subpixel (for example, the subpixel PX21) is located. Specifically, please refer to FIG. 7 to FIG. 12. FIG. 7, FIG. 9 and FIG. 11 are schematic diagrams illustrating subpixel voltages of the subpixels PX11-PXnm during time intervals TT1b, TT1c and TT1d (or time intervals TT2b, TT2c and TT2d) respectively according to an embodiment of the present invention. In FIG. 7, FIG. 9 and FIG. 11, different diagonal stripe patterns indicate different subpixel voltages. FIG. 8 is a timing diagram of the polarity signal Sp1, the gate driving signal G2, the data signal D1, and the subpixel voltage Vpx21 corresponding to FIG. 7. FIG. 10 is a timing diagram of the polarity signal Sp1, the gate driving signal Gx, data signals D1, D1c, and subpixel voltages Vpxx1, Vpxx1c, corresponding to FIG. 9. FIG. 12 is a timing diagram of the polarity signal Sp1, the gate driving signal Gn−1, data signals D1, D1c, and subpixel voltages Vpx(n−1)1, Vpx(n−1)1c, corresponding to FIG. 11. In FIG. 8, FIG. 10 and FIG. 12, thin solid curves represent the data signal D1. Thin dashed curves represent the data signal D1c after compensation. Thick solid curves represent the subpixel voltages Vpx21, Vpxx1 and Vpx(n−1)1, which correspond to charges accumulated in the subpixel PX21, PXx1 and PX(n−1)1, respectively. Thick dashed curves represent the subpixel voltages Vpxx1c and Vpx(n−1)1c, which correspond to charges accumulated in the subpixel PX21, PXx1 and PX(n−1)1 after compensation, respectively.

As shown in FIG. 7 and FIG. 8, by sequentially turning on the gate lines GL1-GLn, sequential activation of the subpixels PX11-PXnm occurs one row at a time during the frame period FP1b. The data lines DL1-DLm transmit the data signals D1-Dm of a gray-level voltage Vp1 from the data driving circuit 126 to the subpixels PX11-PX1m before the time interval TT1b within the frame period FP1b. The data signals D1-Dm sent to the subpixels PX21-PX2m, which are adjacent to the subpixels PX11-PX1m, increases from the gray-level voltage Vp1 (also referred to as a previous voltage) to a gray-level voltage Vph (also referred to as a current voltage) during the time interval TT1b of the frame period FP1b—for instance, from black to white. The data lines DL1-DLm transmit the data signals D1-Dm of the gray-level voltage Vph to the subpixels PX31-PXnm after the time interval TT1b within the frame period FP1b. Since the subpixel voltage Vpx21 of the subpixel PX21 reaches the gray-level voltage Vph during the time interval TT1b and ensures the brightness of the subpixel PX21 as expected, there is no need to compensate the subpixel voltage Vpx21. That is to say, considering the zone ZN11 in which the subpixel PX21 is located and the previous gray-level voltage Vp1 of the data signal D1, the (first) compensation difference between the (first) input gray level data and the (first) output gray level data, which corresponds to the current gray-level voltage Vph of the data signal D1, with positive voltage polarity may be equal or close to zero. Alternatively, the compensation circuit 1221 may not convert the (first) input gray level data into the (first) output gray level data.

Likewise, the data signals D1-Dm sent to the subpixels PX21-PX2m decreases from the gray-level voltage Vn1 (also referred to as a previous voltage) for the adjacent subpixels PX11-PX1m to a gray-level voltage Vnh (also referred to as a current voltage) during the time interval TT2b of the frame period FP2b—for instance, from black to white. Since the subpixel voltage Vpx21 of the subpixel PX21 reaches the gray-level voltage Vnh during the time interval TT2b and ensures the brightness of the subpixel PX21 as expected, there is no need to compensate the subpixel voltage Vpx21. That is to say, considering the zone ZN11 in which the subpixel PX21 is located and the previous gray-level voltage Vn1 of the data signal D1, the (second) compensation difference between the (second) input gray level data and the (second) output gray level data, which corresponds to the current gray-level voltage Vnh of the data signal D1, with negative voltage polarity may be equal or close to zero. Alternatively, the compensation circuit 1221 may not convert the (second) input gray level data into the (second) output gray level data.

As shown in FIG. 9 and FIG. 10, by sequentially turning on the gate lines GL1-GLn, sequential activation of the subpixels PX11-PXnm occurs one row at a time during the frame period FP1b. The data lines DL1-DLm transmit the data signals D1-Dm of the gray-level voltage Vp1 from the data driving circuit 126 to the subpixels PX11-PX(x−1)m before the time interval TT1c within the frame period FP1b. The data signals D1-Dm sent to the subpixels PXx1-PXxm, which are adjacent to the subpixels PX11-PX (x−1) m, increases from the gray-level voltage Vp1 (also referred to as a previous voltage) to the gray-level voltage Vph (also referred to as a current voltage) during the time interval TT1c of the frame period FP1b. The data lines DL1-DLm transmit the data signals D1-Dm of the gray-level voltage Vph to the subpixels PX(x+1)1-PXnm after the time interval TT1c within the frame period FP1b. Since the subpixel voltage Vpxx1 of the subpixel PXx1 reaches the gray-level voltage Vph during the time interval TT1c and ensures the brightness of the subpixel PXx1 as expected, there is no need to compensate the subpixel voltage Vpxx1. That is to say, considering the zone ZNk1 in which the subpixel PXx1 is located and the previous gray-level voltage Vp1 of the data signal D1, the (first) compensation difference between the (first) input gray level data and the (first) output gray level data, which corresponds to the current gray-level voltage Vph of the data signal D1, with positive voltage polarity may be equal or close to zero. Alternatively, the compensation circuit 1221 may not convert the (first) input gray level data into the (first) output gray level data.

On the other hand, the data signals D1-Dm sent to the subpixels PXx1-PXxm decreases from the gray-level voltage Vn1 (also referred to as a previous voltage) for the adjacent subpixels PX11-PX (x−1)m to a gray-level voltage (also referred to as a current voltage) higher than the gray-level voltage Vnh during the time interval TT2c of the frame period FP2b. Compared to the subpixels PX21-PX2m, the subpixels PXx1-PXxm are disposed far from the data driving circuit 126. As shown in FIG. 10, the subpixel voltage Vpxx1 of the subpixel PXx1 fails to reach the gray-level voltage Vnh during the time interval TT2c and cannot match the brightness as expected. The subpixel voltage Vpxx1 and the data signal D1 therefore require compensation to be changed to the subpixel voltage Vpxx1c and the data signal D1c respectively. In this way, the waveform of the subpixel voltage Vpxx1 of the subpixel PXx1 with positive voltage polarity and the waveform of the subpixel voltage Vpxx1c of the subpixel PXx1 with negative voltage polarity are symmetric or balanced with respect to the common voltage VCOM. That is to say, considering the zone ZNk1 in which the subpixel PXx1 is located and the previous gray-level voltage Vn1 of the data signal D1, the (second) compensation difference between the (second) input gray level data and the (second) output gray level data, which corresponds to the current gray-level voltage Vnh of the data signal D1, with negative voltage polarity may be nonzero. The compensation circuit 1221 converts the (second) input gray level data into the (second) output gray level data according to the zone ZNk1 in which the subpixel PXx1 is located according to the voltage polarity of the data signal D1 and according to the previous gray-level voltage Vn1 of the data signal D1 so as to eliminate line afterimage.

As shown in FIG. 11 and FIG. 12, by sequentially turning on the gate lines GL1-GLn, sequential activation of the subpixels PX11-PXnm occurs one row at a time during the frame period FP1b. The data lines DL1-DLm transmit the data signals D1-Dm of the gray-level voltage Vp1 from the data driving circuit 126 to the subpixels PX11-PX(n−2)m before the time interval TT1d within the frame period FP1b. The data signals D1-Dm sent to the subpixels PX (n−1)1-PX(n−1)m, which are adjacent to the subpixels PX11-PX(n−2)m, increases from the gray-level voltage Vp1 (also referred to as a previous voltage) to the gray-level voltage Vph (also referred to as a current voltage) during the time interval TT1d of the frame period FP1b. The data lines DL1-DLm transmit the data signals D1-Dm of the gray-level voltage Vph to the subpixels PXn1-PXnm after the time interval TT1d within the frame period FP1b. Since the subpixel voltage Vpx(n−1)1 of the subpixel PX(n−1)1 reaches the gray-level voltage Vph during the time interval TT1d and ensures the brightness of the subpixel PX(n−1)1 as expected, there is no need to compensate the subpixel voltage Vpx(n−1)1. That is to say, considering the zone ZNi1 in which the subpixel PX(n−1)1 is located and the previous gray-level voltage Vp1 of the data signal D1, the (first) compensation difference between the (first) input gray level data and the (first) output gray level data, which corresponds to the current gray-level voltage Vph of the data signal D1, with positive voltage polarity may be equal or close to zero. Alternatively, the compensation circuit 1221 may not convert the (first) input gray level data into the (first) output gray level data.

On the other hand, the data signals D1-Dm sent to the subpixels PX(n−1)1-PX(n−1)m decreases from the gray-level voltage Vn1 (also referred to as a previous voltage) for the adjacent subpixels PX11-PX(n−2)m to a gray-level voltage (also referred to as a current voltage) much higher than the gray-level voltage Vnh during the time interval TT2d of the frame period FP2b. Compared to the subpixels PX21-PX2m, the subpixels PX(n−1)1-PX(n−1)m are disposed far from the data driving circuit 126. As shown in FIG. 12, the subpixel voltage Vpx(n−1)1 of the subpixel PX(n−1)1 fails to reach the gray-level voltage Vnh during the time interval TT2d and cannot match the brightness as expected. The subpixel voltage Vpx(n−1)1 and the data signal D1 therefore require compensation to be changed to the subpixel voltage Vpx (n−1)1c and the data signal D1c respectively. In this way, the waveform of the subpixel voltage Vpx(n−1)1 of the subpixel PX(n−1)1 with positive voltage polarity and the waveform of the subpixel voltage Vpx(n−1)1c of the subpixel PX(n−1)1 with negative voltage polarity are symmetric or balanced with respect to the common voltage VCOM. That is to say, considering the zone ZNi1 in which the subpixel PX(n−1)1 is located and the previous gray-level voltage Vn1 of the data signal D1, the (second) compensation difference between the (second) input gray level data and the (second) output gray level data, which corresponds to the current gray-level voltage Vnh of the data signal D1, with negative voltage polarity may be much greater than zero. The compensation circuit 1221 converts the (second) input gray level data into the (second) output gray level data according to the zone ZNi1 in which the subpixel PX (n−1)1 is located, according to the voltage polarity of the data signal D1 and according to the previous gray-level voltage Vn1 of the data signal D1 so as to eliminate line afterimage.

To sum up, the compensation differences for a subpixel may be functions of the location of the subpixel. The compensation differences fora subpixel may be affected by the current (gray-level) voltage of the data signal for the subpixel. The compensation differences for the subpixel may vary according to whether the data signal for the subpixel has negative or positive voltage polarity in order to eliminate flicker. The compensation differences for the subpixel may be associated with a previous (gray-level) voltage of the data signal for another adjacent subpixel in order to eliminate line afterimage.

Those skilled in the art will readily observe that numerous modifications and alterations of the device and method may be made while retaining the teachings of the invention. Accordingly, the above disclosure should be construed as limited only by the metes and bounds of the appended claims.

1. A display panel driving circuit, for driving a plurality of subpixels of a display panel, comprising:
a compensation circuit, configured to convert a first input gray level data into a first output gray level data corresponding to a first data signal for a first subpixel of the plurality of subpixels, wherein the first subpixel is located in a first zone of a plurality of zones of the display panel, wherein a first difference between the first input gray level data and the first output gray level data is associated with a first voltage polarity of the first data signal or the first zone, and a first size of the first zone is different from a second size of a second zone of the plurality of zones.

2. The display panel driving circuit of claim 1, wherein the first difference is different from a second difference between a second input gray level data and a second output gray level data converted by the compensation circuit, wherein the first voltage polarity of the first data signal corresponding to the first output gray level data is opposite to a second voltage polarity of a second data signal corresponding to the second output gray level data, wherein the first input gray level data equals the second input gray level data.

3. The display panel driving circuit of claim 1, wherein the first difference equals zero when the first zone is located near a center of the display panel, wherein the first difference is nonzero when the first zone is located near four outermost sides of the display panel.

4. The display panel driving circuit of claim 1, wherein a subpixel voltage of the first subpixel deviates from the first data signal by a voltage associated with the first difference between the first input gray level data and the first output gray level data.

5. The display panel driving circuit of claim 1, wherein a first difference between the first input gray level data and the first output gray level data is associated with a previous voltage of the first data signal, wherein the first output gray level data is associated with a current voltage of the first data signal, wherein the first data signal of the previous voltage is transmitted to a second subpixel of the plurality of subpixels, wherein the second subpixel is adjacent to the first subpixel.

6. The display panel driving circuit of claim 1, wherein the compensation circuit is disposed in a timing controller.

7. The display panel driving circuit of claim 1, wherein the display panel is divided into the plurality of zones, wherein each of the plurality of zones has at least one of the plurality of subpixels disposed in.

8. (canceled)

9. The display panel driving circuit of claim 1, wherein the first input gray level data is converted into the first output gray level data according to a first negative compensation lookup table of at least one negative compensation lookup table for negative voltage polarity or a first positive compensation lookup table of at least one positive compensation lookup table for positive voltage polarity, wherein one of the at least one negative compensation lookup table and one of the at least one positive compensation lookup table are associated with one of the plurality of zones.

10. The display panel driving circuit of claim 1, wherein a first difference between the first input gray level data and the first output gray level data is associated with a current voltage of the first data signal, wherein the first output gray level data is associated with a current voltage of the first data signal.

11. A display panel driving method, for driving a plurality of subpixels of a display panel, comprising:
converting a first input gray level data into a first output gray level data corresponding to a first data signal for a first subpixel of the plurality of subpixels, wherein the first subpixel is located in a first zone of a plurality of zones of the display panel, wherein a first difference between the first input gray level data and the first output gray level data is associated with a first voltage polarity of the first data signal or the first zone, and a first size of the first zone is different from a second size of a second zone of the plurality of zones.

12. The display panel driving method of claim 11, wherein the first difference is different from a second difference between a second input gray level data and a second output gray level data, wherein the first voltage polarity of the first data signal corresponding to the first output gray level data is opposite to a second voltage polarity of a second data signal corresponding to the second output gray level data, wherein the first input gray level data equals the second input gray level data.

13. The display panel driving method of claim 11, wherein the first difference equals zero when the first zone is located near a center of the display panel, wherein the first difference is nonzero when the first zone is located near four outermost sides of the display panel.

14. The display panel driving method of claim 11, wherein a subpixel voltage of the first subpixel deviates from the first data signal by a voltage associated with the first difference between the first input gray level data and the first output gray level data.

15. The display panel driving method of claim 11, wherein a first difference between the first input gray level data and the first output gray level data is associated with a previous voltage of the first data signal, wherein the first output gray level data is associated with a current voltage of the first data signal, wherein the first data signal of the previous voltage is transmitted to a second subpixel of the plurality of subpixels, wherein the second subpixel is adjacent to the first subpixel.

16. The display panel driving method of claim 11, wherein the display panel driving method is performed by a timing controller.

17. The display panel driving method of claim 11, wherein the display panel is divided into the plurality of zones, wherein each of the plurality of zones has at least one of the plurality of subpixels disposed in.

18. (canceled)

19. The display panel driving method of claim 11, wherein the first input gray level data is converted into the first output gray level data according to a first negative compensation lookup table of at least one negative compensation lookup table for negative voltage polarity or a first positive compensation lookup table of at least one positive compensation lookup table for positive voltage polarity, wherein one of the at least one negative compensation lookup table and one of the at least one positive compensation lookup table are associated with one of the plurality of zones.

20. The display panel driving method of claim 11, wherein a first difference between the first input gray level data and the first output gray level data is associated with a current voltage of the first data signal, wherein the first output gray level data is associated with a current voltage of the first data signal.
